(19) United States
(12) Patent Application Publication
(10) Pub. No.: US 2005/0275139 A1
(43) Pub. Date: Dec. 15, 2005

(54) Tool and method to create an accurate cast of the internal form of a component

(76) Inventors: Robert S. Bencze, Atwater, OH (US); Theodore J. Gausman, Painesville, OH (US); Mark V. Gorjanc, Chesterland, OH (US); Brian L. Martin, Cuyahoga Falls, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/514,852

(22) PCT Filed: May 14, 2003
(86) PCT No.: PCT/US03/14991

§ 371 Date: Nov. 12, 2004

Related U.S. Application Data
(60) Provisional application No. 60/378,080, filed on May 15, 2002.

(51) Int. Cl. B28B 7/20

(52) U.S. Cl. 264/318

(57) ABSTRACT

A molding tool (10) has a body (20) that can be inserted into a cavity (62) of a component (12) for introducing molding material (72) to form a mold of one or more internal surfaces (60) defining the cavity (62). The molding material (72) is at least partially cured with the tool (10) in place so that the mold (80) and tool (10) are removed from the cavity (62) as a single unit. The tool (10) includes a passage (34) for introducing the molding material (72) into the cavity (62). A pressure device, such as a plunger (50), may be used to force the molding material (72) through the passage (34) and into the cavity (62). The tool (10) also serves to support the mold (80) on a fixture or other structure used to analyze the mold (80) to verify characteristics of the form, such as, for example, an optical comparator.

### RELATED APPLICATION

This application claims the benefit of U.S. Provisional Application No. 60/378,080 filed on May 15, 2002 for FEMALE FORM MOLD TOOL AND METHOD, the entire disclosure of which is fully incorporated by reference.

### BACKGROUND OF THE INVENTION

Many industrial components include internal openings, such as a cavity or bore or recessed volume, defined by an internal form (internal surface) of the component The internal form may include various surface portions, such as threads or angles or radii. In some cases it is important to be able to measure very accurately the configuration of some or all of the surface portions, or to be able to compare them with a predetermined template to check them for accuracy.

For example, the internal form of the component may include female threads configured to receive external male threads on another component of a connecting or coupling system. For such a connecting or coupling system to operate effectively, the threads present within the female component are manufactured to meet certain specifications and tolerances or to have certain characteristics. Verifying that a female threaded component actually possesses certain characteristics often requires a replica mold or cast of the threads to be made after the component has been manufactured. The analysis is accomplished by placing the mold or cast on an optical comparator or other suitable device. (The terms “mold” and “cast” are used interchangeably herein.)

Creating the mold or cast of an internal form (whether threaded or unthreaded) can be a difficult and laborious process that results in partial or incomplete molds and wasted molding material. Providing positional stability to a mold that has been placed in an optical comparator is also frequently problematic because the molding or casting material is typically a relatively soft and flexible material. Inaccurate comparison data may result if a mold is not stable on the comparator while the analysis is being conducted.

Thus, there is a need for apparatus and methods that consistently produce accurate molds of the internal form of a component and that also provide an arrangement for mounting and immobilizing the mold on an optical comparator or other test equipment for analysis.

### SUMMARY OF THE INVENTION

The invention relates to apparatus and methods for making a replica mold or casting of a form that defines an internal cavity of a component In one embodiment, the invention is realized in the form of a tool having a body that can be at least partially inserted into the cavity of the component for introducing a molding material therethrough. The molding material is at least partially cured with the tool in place so that the mold and tool are removed from the component as a single unit. An application of the invention is for making a mold of a female thread structure within a female nut of a coupling. The finished mold and tool are removed by unscrewing the tool from the component. The tool includes a passageway for introducing the molding material into the internal cavity of the female component, and a pressure device, for example, a plunger, may be used to force the molding material through the passageway and into the cavity. In accordance with another aspect of the invention, the mold tool provides a convenient structure for supporting the mold on a fixture or other structure used to analyze the mold to verify characteristics of the form, such as, for example, an optical comparator.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is an elevational view of a molding tool in accordance with a first embodiment of the present invention, the molding tool including both a mold template and a plunger,

FIG. 2 is a perspective view of the mold template of FIG. 1;

FIG. 3 is a sectional view of the mold template of FIG. 1, taken along line 3-3 of FIG. 1;

FIG. 4 is an elevational view, partially in section, showing the molding tool of FIG. 1 in use for making a mold of an internal form of a component;

FIG. 5 is a schematic view illustrating the supporting of the mold template of FIG. 1 with the mold thereon for analysis by an optical comparator,

FIG. 6 is a sectional view similar to FIG. 3 of the mold template with the mold thereon, taken along line 6-6 of FIG. 5;

FIG. 7 is a view similar to FIG. 1 of a molding tool in accordance with a second embodiment of the present invention, the molding tool including a threaded plunger,

FIGS. 8 and 9 are views of a molding tool in accordance with a third embodiment of the invention, shown in use for making a mold of a non-threaded cavity in a component;

FIGS. 10 and 11 are views of a molding tool in accordance with a fourth embodiment of the invention, shown in use for making a mold of a longitudinal portion only of a deep cavity in a component;

FIGS. 12-17 are a series of views of a molding tool in accordance with a fifth embodiment of the invention, shown in use for making a mold of a circumferential portion only of a cavity in a component;

FIG. 18 is a view of a molding tool in accordance with a sixth embodiment of the invention, including a dispenser for a two part molding material; and

FIG. 19 is a view of a molding tool in accordance with a seventh embodiment of the invention, in which the mold template has a multi-piece construction.

### DETAILED DESCRIPTION

The present invention provides a device or tool for creating an accurate cast or mold of the internal form of a component This mold may be used to inspect and verify the characteristics, including dimensions, of the internal form of the component. This invention also provides an arrangement for mounting and immobilizing the mold on an optical comparator or other equipment for analysis. The invention is applicable to various devices or tools for determining whether a part has been manufactured to specification.

The present invention may be readily applied to produce molds of a wide variety of internal forms in a component having an internal geometry, including but not limited to threads, tapers, chamfers, counter bores, recesses and so on, to name a few examples.

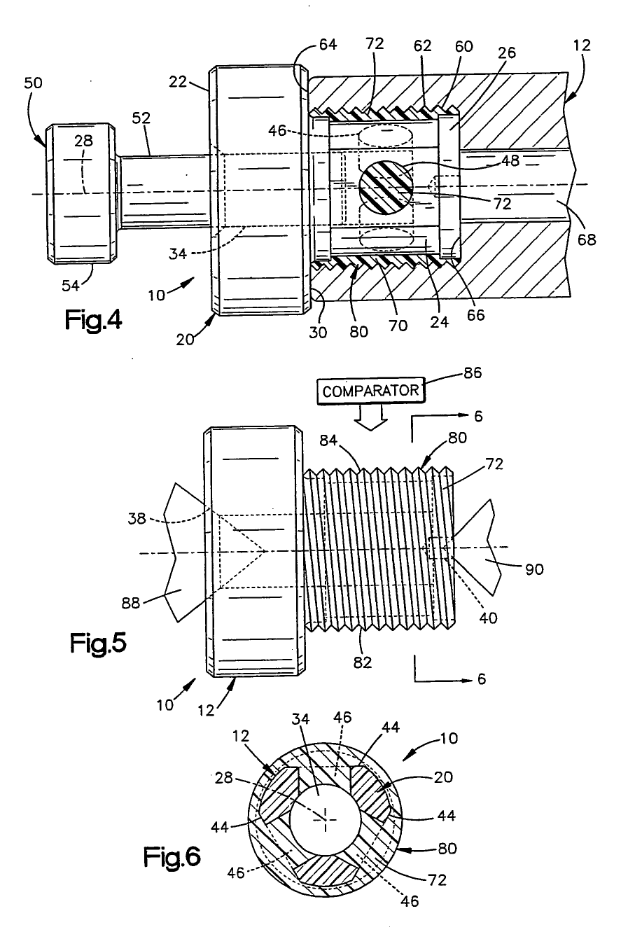

As representative of the invention, FIG. 1 illustrates a tool 10 constructed in accordance with a first embodiment of the invention. The tool 10 is specifically adapted for making a mold of an internally threaded component 12 (FIG. 4).

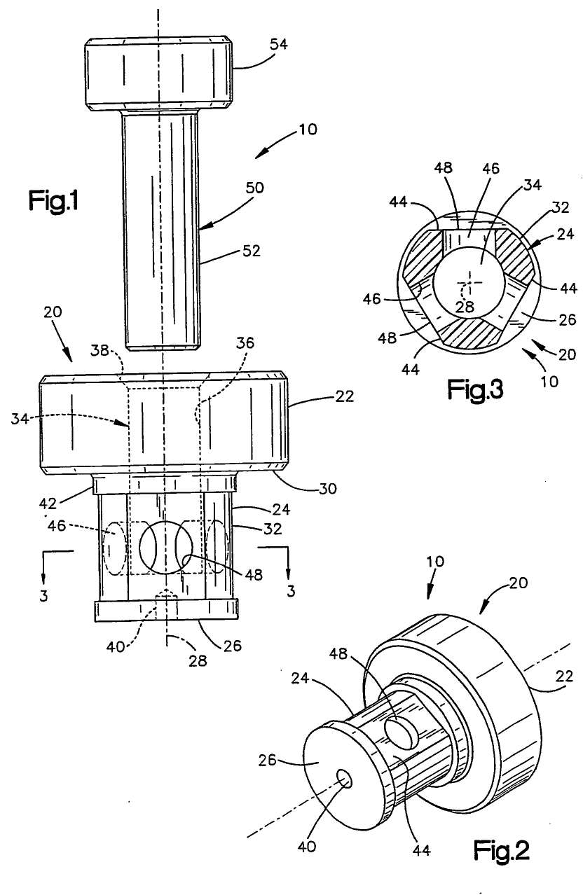

The tool 10 includes a mold template 20 and a pressure member or plunger 50. The mold template 20 (FIGS. 1 and 2) is preferably formed as one piece. The material of the mold template 20 is selected so that the mold template is rigid. Thus, the mold template 20 is firm enough so that it can be placed in or on an optical comparator or other analytical instrument and held in place so that a mold that is on the mold template 20 is supported in a stable manner and can be properly analyzed by the instrument.

The mold template 20 includes a first collar 22, a molding cylinder 24 and an end cap 26. The first collar 22 has a generally cylindrical configuration centered on a longitudinal central axis 28 of the mold template 20. The first collar 22 has an inner side surface 30.

The first collar 22 is preferably greater in diameter than the molding cylinder 24 and is adapted to be easily grasped by the hand of an operator to remove the mold template 20 from association with the component that is being analyzed The first collar 22 may also include wrenching flats (not shown) for rotating the mold template 20 about the axis 28 with the aid of a tool, such as a wrench.

The molding cylinder 24 is a generally cylindrical body that extends axially from the the first collar 22. The molding cylinder 24 has a cylindrical outer surface 32 centered on the axis 28.

A central bore or passage 34 of the mold template 20, defined by a cylindrical surface 36, extends completely through the first collar 22 and through roughly three-fourths the length of the molding cylinder 24. The passage 34 is closed by the inner end of the molding cylinder 24.

The outer end of the passage 34 terminates in a chamfer 38 in the first collar 22. The chamfer 38 is centered on the axis 28. The chamfer 38 may be used to help support the mold template 20 on an optical comparator or other analytical device or equipment, for example, in a manner described below.

The end cap 26 is disposed at the end of the molding cylinder 24 opposite the first collar 22. The end cap 26 is slightly greater in diameter than the molding cylinder 24. The end cap 26 is dimensioned to be just small enough to enter the cavity being molded.

A notch 40 is formed in the radially extending outer end surface of the end cap 26. The notch 40 is located on the axis 28. The notch 40 may be used to help support the mold template 20 on an optical comparator or other analytical device or equipment, for example, in a manner as described below.

The mold template 20 includes a retaining and positioning ring 42 that encircles the molding cylinder 24 at the point where the molding cylinder extends from the first collar 22. The ring 42 is roughly equal in diameter to the diameter of the end cap 26. Thus, in a preferred embodiment, the diameter of the molding cylinder 24 is slightly less than the diameters of the ring 42 and of the end cap 26. This configuration provides a means for retaining molding material inside the cavity being molded, thereby reducing the tendency of the molding material to escape or leak out of the thread component. The ring 42 and the cap 26 act as dams to resist flow of the molding material outside the form volume being molded and also to help ensure flow of the material into all the spaces of the form.

The molding cylinder 24 further comprises one or a plurality of flat surfaces 44. In a preferred embodiment of this invention, three flat surfaces 44 are provided on the molding cylinder 24, spaced apart at 120° intervals about the axis 28. The flat surfaces 44 are preferably, but not necessarily, located near the inner end of the molding cylinder 24.

Three radial passages 46 extend between the central passage 34 of the mold template 20 and the flat surfaces 44. The radial passages 46 terminate in respective apertures 48 formed in the flat surfaces 24. Preferably, each aperture 48 is centrally positioned, lengthwise and widthwise, on its associated flat surface 44.

The pressure member 50 is a component that may be used to apply pressure to molding material, as described below, to squeeze molding material through the passage 34 and out the apertures 48. The pressure member 50 may therefore take on many configurations other than those illustrated herein. In the embodiment in FIGS. 1-6, the pressure member 50 is a device that is separate and distinct from the mold template 20. In other embodiments, the pressure member 50 may be a component that is not physically separate from the template 20, or may be a separate component that is attached. The pressure member 50 is preferably but not necessarily manufactured from the same material as the mold template 12, such as nylon or other suitable materials.

The pressure member 50 that is shown in FIGS. 1 and 4 is a plunger. The plunger 50 includes a main body portion 52 having an elongate cylindrical configuration with a diameter slightly less than that of the central bore 34 of the template 20. The plunger 50 preferably further includes at its outer end a second collar 54 which may be easily grasped by hand of an operator to depress and retract the plunger 50. The second collar 54 of the plunger 50 is larger in diameter than the main body portion 52.

In the embodiment illustrated in FIGS. 1-6, the component 12 to be analyzed (FIG. 4) is a coupling part having an internal thread convolution 60 defining a cavity 62 of the component. The component 12 also has an outer end face 64 and an inner end face 66 at opposite ends of the cavity 62. The component 12 further has a fluid passage 68 extending from the inner end face 66 in a direction away from the cavity 62. The thread convolution 60 has crests, troughs, a pitch, etc. The molding tool 10 may be used in the following manner to analyze the thread convolution 60 of the component 12 to determine whether it has been manufactured to specification.

In operation, the molding cylinder 24 of the mold template 20 is inserted into the cavity 62 of the component 12, as shown in FIG. 4. The inner side surface 30 of the first collar 22 preferably but not necessarily engages the outer end face 64 of the component 12. The end cap 26 preferably engages the inner end face 66 of the component As a result, the mold template 20 at least partially closes the cavity 62. The molding cylinder 24 is spaced radially inward a small amount from the thread convolution 60, thus defining an annular molding cavity or space 70.

An appropriate quantity of molding material 72 is inserted in the central bore 34 of the mold template 20 through the end of the passage 34 in the first collar 22. A preferred molding material 72 is REPRORUBBER brand molding material. This material 72 is available from Flexbar Machine Corp. of Central Islip, N.Y. Other molding materials 72 are usable. The preferred molding material 72, when cured, is generally not rigid enough to support itself in a stable manner as needed for analysis on an optical comparator.

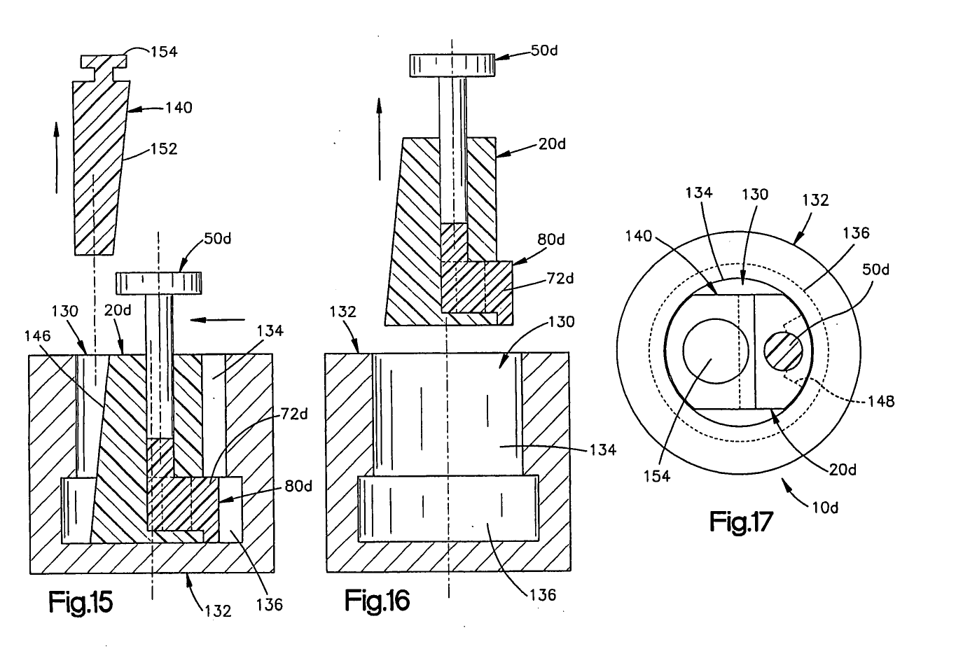

It may be feasible to use the passage 34 in the mold template 20 to measure the appropriate quantity of molding material 72. To do this, the size of the passage 34 would be selected to provide the correct amount of molding material 72 for the mold to be cast in that particular operation. Appropriate quantity markers could be placed on the mold tool 10. Controlling the quantity of molding material 72 that is used is especially desirable when a mold is to be made of only a limited portion of a cavity, as discussed below, for example, with reference to FIGS. 12-17.

The main body portion 52 of the plunger 50 is inserted at least partially into the central bore 34 of the mold template 20. Pressure is manually applied to the molding material 72 by pushing axially on the plunger 50. The force applied to the plunger 50 causes the molding material 72 to flow axially through the central bore 34 into the radial passages 46 in the mold template 20 and radially out the apertures 48. The molding material 72 enters the annular space 70 between the mold template 20 and the thread convolution 60. The plunger 50 is dimensioned to be a close fit in the mold template 20, to prevent molding material 72 from coming back out around the plunger.

The recessed flat surfaces 44 provide additional open space to help the molding material 72 to flow from the molding cylinder 24 into the molding space 70. The molding material 72 also flows into the form volume such as the spaces between adjacent threads of the thread convolution 60 component. Sufficient pressure is applied to force the molding material 72 completely into all the spaces and against all the surfaces that define the cavity 62 of the component 12. A substantial amount of pressure may be needed to force out any air from the cavity 62 and the molding material 72. Excess air in the cavity 62 is vented around the diametrical clearance between the molding tool 10 and the part 12 being molded.

The molding material 72 is forced into intimate contact with the internal form of the component 12. Sufficient time is allowed for the molding material 72 to fill all the desired spaces. A mold 80 is formed having an outer surface 82 that is an exact replica of the inner surface of the component 12.

After a period of time sufficient for the molding material 72 to harden or at least partially cure or solidify enough for removal without altering the shape of the mold 80, the mold template 20 is removed from the component 12 by grasping the first collar 22 and unscrewing the mold template (FIG. 3). The molding material 72 releases from the component 12 but sticks to the mold template 20, and so the mold 80 comes out of the cavity with the mold template. The presence of cured molding material 72 in the radially extending passages 46 helps to interlock the mold 80 and the mold template 20. In addition, the flat surfaces 44 on the mold template 20 act as bearing surfaces that transmit the rotational force of the mold template 20 to the mold 80, better than a cylindrical surface would do, to help rotate the mold relative to the component 12. The plunger 50 may be removed before or after the mold template 20 is removed from the component 12.

The resulting assembly is shown in FIGS. 5 and 6 and includes the mold template 20 and the mold 80. The mold 80 has an annular (hollow) configuration extending 360 degrees around the molding cylinder 24 of the mold template 20. The exterior surface 82 of the mold 80 is an exact replica of the internal surface of the component 12. In this case, the mold 80 has an external thread convolution 84 that replicates the internal thread convolution 60 of the component 12. The external thread convolution 84 is visible on the exterior of the mold template 20. Thus, an accurate, measurable mold or replica of the interior threads of the female thread component 12 is present on the exterior of molding cylinder 24.

The finished mold 80, to be analyzed, is placed on an optical comparator or other equipment as illustrated schematically at 86 in FIG. 5. The mold 80 is supported on the comparator 86 by the mold template 20. The mold template 20 is supported in position on the comparator 86 by centers 88 and 90. The center 88 engages in the chamfer 38 on the first collar 22 of the mold template 20. The center 90 engages in the notch 40 in the end cap 26 of the mold template 20.

Because the mold template 20 is a rigid member, the mold template is supported firmly in position on the optical comparator 86. As a result, the mold 80, itself, is firmly and in a stable manner supported in position on the optical comparator 86 so that a proper analysis of the external thread convolution 84 can be made. For example, the assembly of the mold template 20 and the mold 80 can be accurately positioned within 1/1000 of an inch on the comparator 86. This is often not possible with an unsupported plug of cured molding material 72. Many other supporting arrangements for the completed mold 80 are possible and will be readily apparent to those skilled in the art. For example, rather than a notch or chamfer, a raised boss may be provided on the mold template 20 for clamping in a fixture. In addition, the plunger 50 may be left in the mold template 20, and the plunger used to help support the mold 80 in the analyzing device.

Advantageously, the tool 10 may be reused, as the mold 80 simply peels away from the cylinder 24 after the analysis is completed. In addition, because the molding cylinder 24 is located within the mold 80, the mold is only a relatively thin walled cylinder of molding material 72 rather than a solid plug of molding material. This reduces usage of the expensive molding material 72.

By way of example and not limitation, the diameter of the ring 42 and the diameter of the end cap 26 may be the same as each other, and may be slightly smaller than the part being measured, for example about 0.02 inches smaller for small parts and about 0.04 inches for larger parts. The diameter of the cylinder 20 may be about 0.04 inches smaller than the diameters of the ring 42 and the end cap 26.

Still further by way of example, the total length represented by the ring 42, the cylinder 24 and the end cap 26 may be about 0.03 inches shorter than the depth of the cavity being measured for small parts and about 0.06 inches shorter than the cavity being measured for larger parts. As used herein and still by way of example, a “small” part may be a part such as a ¼ inch fitting and under and a “larger” part may be a part such as an over ¼ inch fitting.

In the embodiment of FIGS. 1-6, the mold 80 is formed with the template 20 in place so as to facilitate removal of the mold after cure. However, it is possible to remove the template 20 if required as soon as the molding material 70 has been introduced into the component 12. In such a case the finished mold 80 can still be unscrewed from the component 12 but might not be as rigidly supported for the test equipment.

Both the mold template 20 and the plunger 50 are scalable, meaning that each may be adapted to a variety of dimensional requirements. For example, to mold the threads of a female thread component having a smaller internal diameter, the molding cylinder may be made smaller.

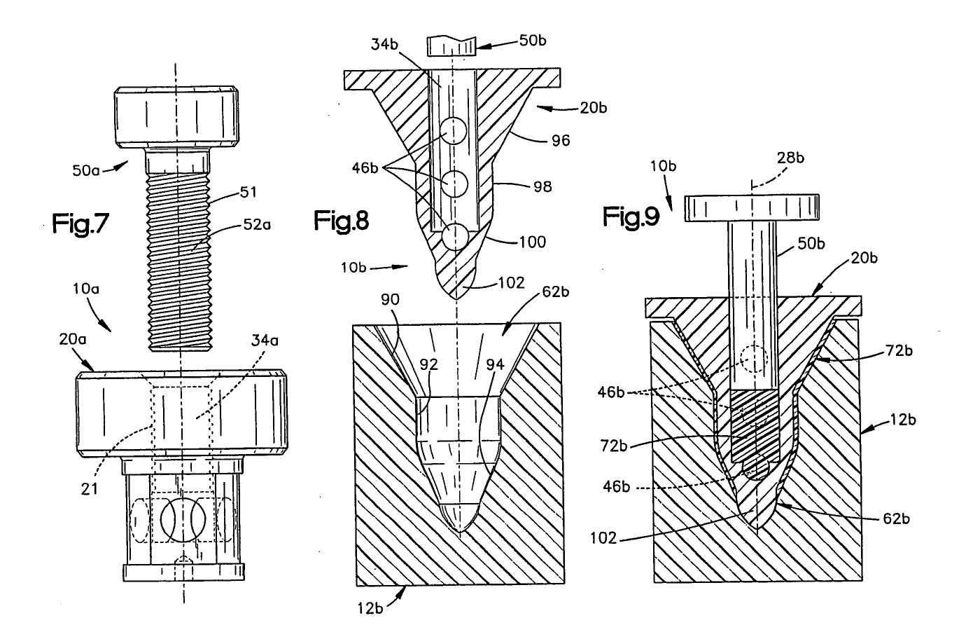

FIG. 7 illustrates a molding tool 110a constructed in accordance with a second embodiment of the invention. The molding tool 110a is similar in construction to the molding tool 10 (FIGS. 1-6), and parts that are the same or similar are given the same reference numerals with the suffix “a” attached

The molding tool 10a (FIG. 7) includes a plunger 50a having an external thread convolution 51 on the main body portion 52a of the plunger. The mold template 20a includes an internal thread convolution 21 along a portion of the length of its central passage 34a.

The plunger 50a can, as a result, be screwed into the mold template 20a during introduction of molding material, rather than being pushed in without rotating as in the first embodiment. The mechanical advantage of the screw threaded connection between the plunger 50a and the mold template 20a can help the operator apply more pressure during introduction of molding material. This can help to ensure that the molding material is moved into intimate contact with all portions of the internal form to be analyzed.

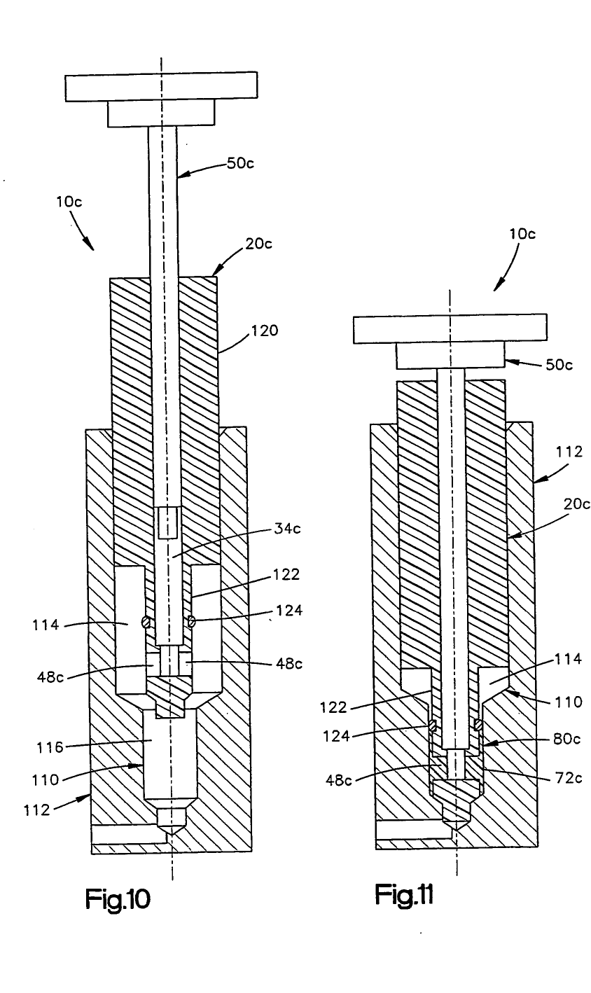

FIGS. 8 and 9 illustrate a molding tool 10b constructed in accordance with a third embodiment of the invention. The molding tool 10b is similar in construction to the molding tool 10 (FIGS. 1-6), and parts that are the same or similar are given the same reference numerals with the suffix “b” attached.

The molding tool 10b (FIGS. 8 and 9) is adapted for use in producing a mold of a cavity 62a in a component 12a. The cavity 62a has a non-cylindrical configuration as defined by a tapering surface 90, a cylindrical surface 92, and another tapering surface 94. The cavity 62a is not internally threaded; the invention is applicable to the molding of replicas of non-threaded cavities in addition to the molding of threaded cavities as shown in FIGS. 1-6.

The mold template 20b (FIG. 8) has a configuration complementary to that of the cavity 62a. Thus, the mold template 20b has an external surface including a tapering surface 96, a cylindrical surface 98, and another tapering surface 100. The mold template 20b includes an axially extending central passage 34b for the introduction of molding material 72a into the cavity 62a in the component 12a.

The central passage 34b opens into three radially extending passages 46b in the mold template 20b. The passages 46b are spaced axially along the length of the mold template 20b, at locations that are adjacent the component surfaces to be replicated when the mold template is in position in the cavity 62a. As a result, the molding material 72a (FIG. 9), when forced into the cavity 62a by the plunger 50b, is forced radially outward to the desired locations in the cavity against the surfaces 90, 92 and 94.

The mold template 20b has a tip 102 that engages the component 12a. This engagement blocks flow of molding material 72a into the inner end portion of the cavity 62a and also centers and stabilizes the mold template 20b in the cavity.

FIGS. 10 and 11 illustrate a molding tool 10c constructed in accordance with a fourth embodiment of the invention. The molding tool 10c is similar in construction to the molding tool 10 (FIGS. 1-6), and parts that are the same or similar are given the same reference numerals with the suffix “c” attached.

The molding tool 10c (FIGS. 10 and 11) is adapted for use in producing a mold of a specific longitudinal portion only of a deep cavity 110 in a component 112. Other tools can be constructed in accordance with the invention for molding at a particular depth along the length of a cavity, or for molding more deeply in a cavity than, for example, the mold tool of FIG. 1.

The cavity 110 has a two-part cylindrical configuration including a larger diameter outer chamber section 114 and a smaller diameter inner chamber section 116. In the illustrated embodiment, the inner chamber section 116 is to be molded for analysis. The inner chamber section 116 may be more than halfway into the overall cavity 110. The inner chamber section 116 may be, for example, the deepest 10% or 20% of the overall cavity 110.

The mold template 20c has a configuration complementary to that of the cavity 110. Specifically, the mold template 20c has a relatively long outer portion 120 with a cylindrical configuration. A shorter inner portion 122 of the mold template 20c extends from the outer portion 120. The inner portion 122 has a cylindrical configuration and is smaller in diameter than the outer portion 120.

The mold template 20c includes an axially extending central passage 34c for the introduction of molding material 72c into the cavity 110 in the component 112. The central passage 34c opens into two radially extending ports or apertures 48c in the mold template 20c. The apertures 48c are located circumferentially opposite each other on the inner portion 122 of the mold template 20c. The mold template 20c also includes a circumferential seal 124 located on the inner portion 122 above (outward of) the apertures 48c.

The molding material 72c (FIG. 11), when forced into the cavity 110 by the plunger 50c, is forced radially outward through the apertures 48c to the desired locations in the cavity. The seal 124 blocks axially outward flow of the molding material 72c. The engagement of the tip of the mold template 20c with the component 112 blocks axially inward flow of molding material 72c. As a result, the molding material 72c is trapped axially between the seal 124 and the mold template tip, for forming a mold 80c of a portion of the inner chamber section 116 but not the outer chamber section 114.

When the mold 80c is at least partially cured, the mold template 20c can be removed from the cavity 110 in the component 112, bringing the mold with it. The mold 80c is securely supported on the rigid mold template 20c and thus is suitable for imaging on, for example, an optical comparator.

FIGS. 12-17 illustrate a molding tool 10d constructed in accordance with a fifth embodiment of the invention. The molding tool 10d (FIGS. 10 and 11) is adapted for use in producing a mold 80d of a circumferential portion only, less than 360 degrees, of a cavity 130 in a component 132. Other molding tool configurations are possible for molding a limited circumferential portion of a cavity.

The cavity 130 (FIG. 12) has an undercut, cylindrical configuration, including a smaller diameter outer chamber section 134 defined by a surface 144 and a larger diameter inner chamber section 136 defined by a surface 138. In the illustrated embodiment, a portion of the inner chamber section 136 is to be molded for analysis. Because the chamber portion 136 to be molded is undercut, it would be difficult or impossible to mold (replicate) the entire inner chamber portion and remove the mold from the cavity. Therefore, only a portion of the cylindrical surface 138 defining the inner chamber portion 136 is molded, as described below.

The molding tool 10d includes a mold template 20d and a plunger 50d. The molding tool 10d also includes a wedge 140 for helping to position the mold template 20d in the cavity 130.

The mold template 20d has a cylindrical outer surface 142 for engagement with the surface 144 defining the outer chamber section 134 of the cavity 130. The mold template 20d also has a planar wedge surface 146 opposite the cylindrical surface 144. The mold template 20d is sized so that it fills only a portion of the cavity 130 in the component 132. A central passage 34d in the mold template 20d communicates with an opening 148 in the cylindrical outer surface 142 adjacent the lower end of the mold template. The opening 148 extends for only a portion of the circumferential extent of the mold template 20d. In the illustrated embodiment, the opening 148 extends for about sixty degrees.

The wedge 140 has a configuration complementary to that of the mold template 20d. The wedge 140 is sized and configured so that it fits into the portion of the cavity 130 not filled by the mold template 20d. The wedge 140 has a cylindrical side surface 150 and a planar wedge surface 152. The wedge 140 has a handle 154 on its outer end for manipulation of the wedge.

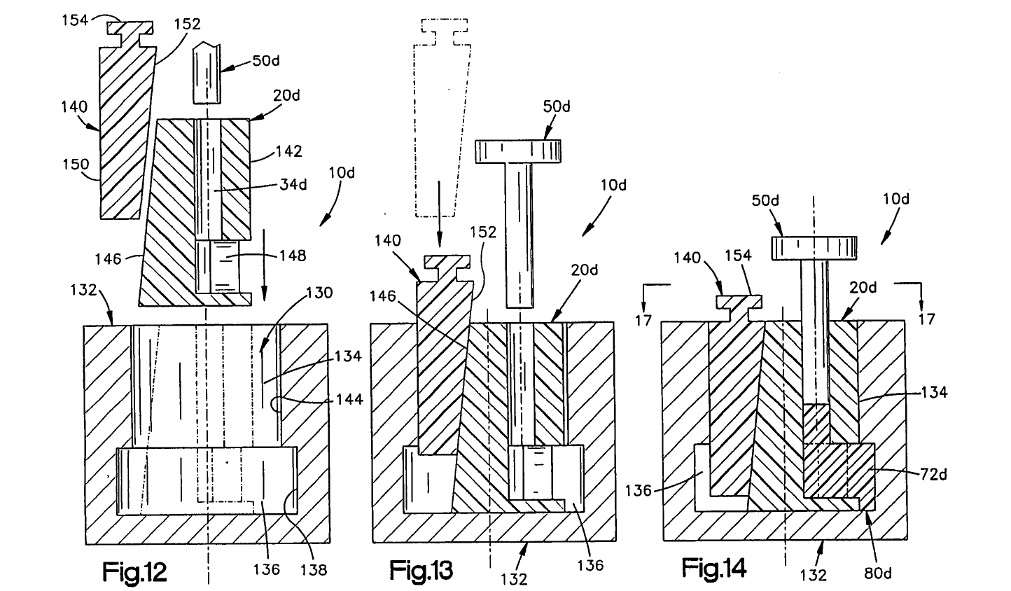

The molding tool 10d is used by first inserting the mold template 20d into the cavity 130, as shown in FIG. 13, until it either bottoms out or is at the appropriate depth. The wedge 140 is then inserted adjacent the mold template 20d. The wedge surface 152 on the wedge 140 engages the wedge surface 146 on the mold template 20d. The cylindrical surface 142 on the wedge 140 engages the cylindrical surface 144 defining the outer chamber portion 134 on the component 132.

As the wedge 140 moves farther down into the cavity 130, the wedge forces the mold template 20d to move radially (sideways) against the cylindrical surface 144 defining the outer chamber portion 134 on the component 132, as shown in FIG. 14.

The molding material 72d (FIG. 14) is then introduced into the cavity 130 through the central passage 34d in the mold template 20d. The plunger 50d is used to force the molding material 72d out the opening 148 into the inner chamber portion 136. The molding material 72d flows radially outward into intimate contact with the cylindrical surface 138 defining the inner chamber portion 136. The amount of molding material 72d used is intentionally limited so that only a circumferential portion, not all, of the inner chamber portion 136 is molded.

When the molding material 72d is at least partially cured, the wedge 140 is removed from the cavity 130 in the component 132, by lifting on the handle 154, as shown in FIG. 15. When the wedge 140 is thus out of the cavity 130, the mold template 20d, with the mold 80d attached, is moved sideways in the cavity, as shown in FIG. 15, so that the mold is no longer in the undercut area. The mold template 20d, with the mold 80d attached, is then lifted out of the cavity 130, possibly by using the plunger 50d as a handle, as shown in FIG. 16. The mold 80d as supported on the mold template 20d may then be analyzed.

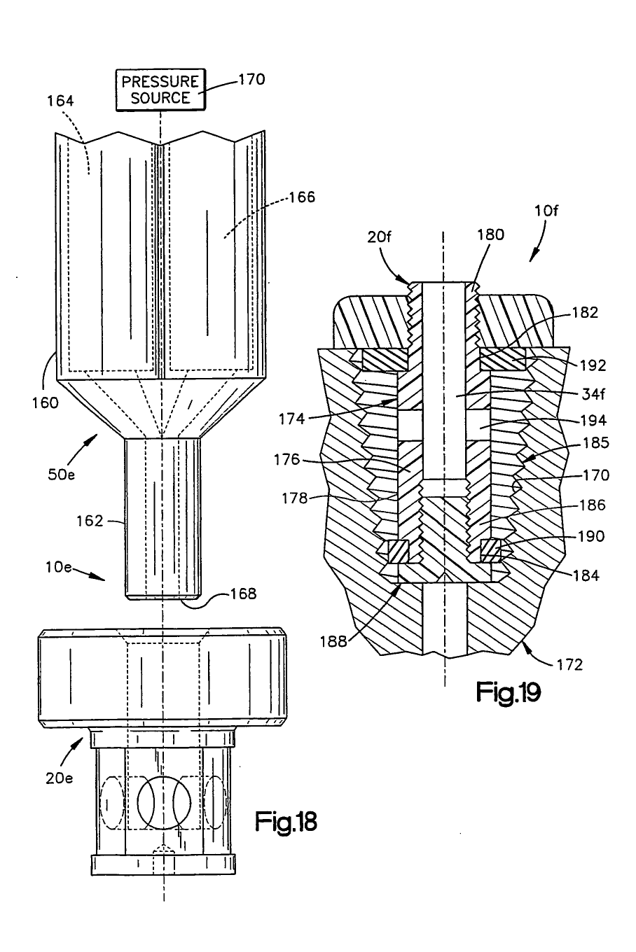

FIG. 18 illustrates a molding tool 10e in accordance with a sixth embodiment of the invention, for use with a two-part molding material. The two-part molding material is provided by a plunger 50e. The plunger 50e has first and second chambers 164 and 166 separated from each other. The two chambers 164 and 166 come together in a tip 162 which has an outlet 168.

The two parts of the molding material are placed in the two chambers 164 and 166, respectively, plunger 50e. A pressure source indicated schematically at 170 applies pressure simultaneously to both chambers 164 and 166. The two parts of the molding material are forced into the tip 162 where they commingle. The resulting molding material is forced out of the tip 162 into a mold template 20e. In FIG. 18, the mold template 20e shown is similar to the mold template 10 (FIG. 1-6). Other mold templates may be used.

FIG. 19 illustrates a molding tool 10f in accordance with a seventh embodiment of the invention, in which the mold template 20f has a multi-piece construction. The molding tool 10f is shown as being used to mold a tapered, internally threaded, surface 170 of a component 172, such as a female pipe thread. The molding tool 10f can be used to mold other types of surfaces, or other types of threads, and other molding tools in accordance with the invention can be used to mold this type of surface.

The mold template 20f includes a main body portion 174 having a cylindrical configuration. A first section 176 of the main body portion 174 has a cylindrical outer side surface 178. An outer section 180 of the main body portion 174 projects outward from the first section 176. The outer section 180 is smaller in diameter than the first section 176. Part of the outer section 180 is externally threaded and part has a smooth cylindrical configuration that forms an annular recess or groove 182. At its opposite end, the main body portion 174 has a reduced diameter annular recess or groove 184.

The main body portion 174 of the mold template 20f is provided with a central passage 34f for the introduction of molding material into the cavity 185 of the component 172. The central passage 34f extends completely through the main body portion 174 of the mold template 20f. The passage 34f is internally threaded at the inner end portion 186 of the main body portion 174. The molding tool 10f also includes an end plug 188. The end plug 188 is adapted to screw into the internally threaded inner end portion 186 of the main body portion 174 of the mold template 20f.

The molding tool 10f also includes an inner ring 190. The inner ring 190 is adapted to fit into the inner recess 184 in the main body portion 174 of the mold template 20f, and to engage the internal thread convolution 170 on the component 172. The inner ring 190 acts to stabilize and center the mold template 20f in the cavity 185.

The inner ring 190 may be made from a rigid material, such as metal. In this case, the inner ring 190 may be selected from a group of inner rings of different outer diameters. As a result, the inner ring 190 is adapted to engage internal surfaces of different diameters. The inner ring 190 may, alternatively, be made from a flexible material, such as rubber. In this case, the inner ring 190 can be compressed to vary its diameter to enable it to engage internal surfaces of different diameters.

The molding tool 10f also includes an outer ring 192. The outer ring 192 is adapted to fit into the outer recess 182 in the main body portion 174 of the mold template 20f, and to engage the internal thread convolution 170 on the component 172. The outer ring 192 thus acts to hold the molding material in the cavity 185 and to stabilize and center the mold template 20f in the cavity.

The outer ring 192 may be made from a rigid material, such as metal. In this case, the outer ring 192 may be selected from a group of outer rings of different outer diameters. As a result, the outer ring 192 is adapted to engage internal surfaces of different diameters. The outer ring 192 may, alternatively, be made from a flexible material, such as rubber. In this case, the outer ring 192 can be compressed to vary its diameter to enable it to engage internal surfaces of different diameters. In the illustrated embodiment, the outside diameter of the outer ring 192 is larger than the outside diameter of the inner ring 190. This size difference enables the mold template 20f to fit closely within the tapered cavity 185.

The main body portion 174 of the mold template 20f includes one or more radial passages 194 that enable flow of molding material from the central passage 34f into the cavity 185. When the plunger (not shown) is inserted into the mold template 20f, the molding material is forced through the central passage 34f and out the radial passages 194, into intimate contact with the internal surface 170 on the component 172. The end plug 188 blocks flow of molding material out of the inner end portion 186 of the central passage 34f. The inner and outer rings 190 and 192 block flow of molding material out of the cavity 185.

After the molding material is cured or at least partially cured, the mold template 20f with the mold thereon is removed from the cavity 185 by unscrewing. The mold 80f can then be analyzed, supported on the mold template 20f. After the mold 80f has been analyzed, it can be stripped off the mold template 20f, and the mold template can be reused, possibly with different sized inner and outer rings 190 and 192.

From the above description of the invention, those skilled in the art will perceive improvements, changes, and modifications in the invention. Such improvements, changes, and modifications within the skill of the art are intended to be included within the scope of the appended claims.

1-40. (canceled)

41. A method of making a cast of an internal form that at least partially defines a cavity in a component, said method comprising the steps of:
providing a molding tool having a molding body with a passage extending through the molding body;
inserting a first portion of the molding body into the cavity, wherein a second portion of the molding body is at least partially outside of the cavity;
introducing a molding material through the passage into the cavity while the first portion of the molding tool is in the cavity; and
at least partially curing the molding material to form a cast;
removing the molding body and cast from the cavity without disassembling the molding body.

42. The method of claim 41 wherein said step of at least partially curing the molding material includes adhering the molding material to the molding tool, and wherein said step of removing the molding tool includes removing the molding tool with the cast supported on the molding tool.

43. The method of claim 41 wherein said step of removing the molding tool comprises manually grasping a portion of the molding tool.

44. The method of claim 41 wherein said step of removing the molding tool is performed by unscrewing the molding tool with the cast thereon from the component.

45. The method of claim 41 wherein said step of providing a molding tool comprises providing a rigid molding tool, and further including placing the rigid molding tool with the cast supported thereon adjacent an optical comparator, and using the optical comparator to analyze the cast.

46. The method of claim 41 wherein said step of introducing a molding material comprises forcing molding material against an internal thread convolution in the component to form a cast of the thread convolution.

47. The method of claim 41 wherein said introducing step comprises forcing the molding material into intimate contact with the internal form of the component.

48. The method of claim 47 wherein said forcing step includes moving a pressure member at least partially into the passage in the molding tool to force the molding material through the passage and out of the molding tool into intimate contact with the internal form of the component.

49. The method of claim 41 wherein said step of introducing a molding material comprises directing molding material out of the molding body through a plurality of circumferentially spaced passages in the molding body.

50. A tool for making a cast of an internal form that at least partially defines a cavity in a component, said tool comprising:
a body having a first portion adapted to be inserted into the cavity;
said body having a second portion with a first opening therein, said second portion adapted to at least partially reside outside of the cavity when said first portion is inserted in the cavity;
a passageway that extends from said first opening to a second opening in said body with said second opening being within the cavity after said first end portion of said body is inserted into the cavity; and
a pressure member for applying pressure to a molding material introduced into said passageway through said first opening,
wherein said body and said cast can be removed from said cavity without disassembling said body.

51. The tool of claim 50 wherein said pressure member is a plunger adapted to be inserted into said passageway through said first opening to force the molding material through said second opening into the cavity.

52. A tool as set forth in claim 51 wherein said body and said pressure member have threads for enabling screwing of said pressure member at least partially into said passageway.

53. The tool of claim 50 comprising a collar associated with said body and adapted to be manually grasped to remove the tool, and the cast thereon, from the cavity by unscrewing after the cast has been completed.

54. The tool of claim 50 where said first portion is adapted to form a cast of an internal form that at least partially includes a thread convolution.

55. The tool of claim 50 wherein said body is rigid enough to support properly the cast on an analytical instrument, such as an optical comparator, and said body has portions adapted to engage one or more supports associated with the analytical instrument.

56. The tool of claim 50 wherein said body is a generally cylindrical body and wherein said second portion of said body is axially closed, said second opening being axially spaced from said second portion.

57. The tool of claim 50 where said body if formed as a single-piece.

58. A tool as set forth in claim 50 wherein said passageway includes a plurality of circumferentially spaced passages and said second opening includes a plurality of circumferentially spaced apertures.
